(19) United States
(12) Patent Application Publication
(10) Pub. No.: US 2006/0277054 A1
(43) Pub. Date: Dec. 7, 2006

(54) Litigation management via network facility

(75) Inventors: Albert Benzrihem, Davie, FL (US); Henry Seiden, Delray Beach, FL (US)

Correspondence Address: Mark Terry, Esq., 227 Michigan Av. #204, Miami Beach, FL, 33139, US

(73) Assignee: CourtEasy, Inc.

(21) Appl. No.: 11/142,974

(22) Filed: Jun. 2, 2005

(51) Int. Cl. G06Q 99/00; H04L 9/00; H04K 1/00

(52) U.S. Cl. 705/1; 705/80

(57) ABSTRACT

A method on a computer for providing litigation management is disclosed. The method includes receiving from a first party to a lawsuit at least one proposed action and logging a time and date of the proposed action. The method further includes sending a message to at least one opposing party in the law suit, wherein the message invites feedback from the at least one opposing party in accordance with a court rule. In one alternative, the method further includes receiving feedback from the at least one opposing party in the law suit, logging a time, a date and content of the feedback, determining whether the feedback complies with the court rule based on the time, date and content of the feedback, and recommending sanctions of the at least one opposing party if the feedback does not comply with the court rule.

### CROSS-REFERENCE TO RELATED APPLICATIONS

Not Applicable.

### STATEMENT REGARDING FEDERALLY SPONSORED RESEARCH OR DEVELOPMENT

Not Applicable.

### INCORPORATION BY REFERENCE OF MATERIAL SUBMITTED ON A COMPACT DISC

Not Applicable.

### FIELD OF THE INVENTION

This invention generally relates to the field of on-line litigation management and more specifically to litigation management for insuring attorney good faith compliance with court requirements and procedures.

### BACKGROUND OF THE INVENTION

Civil litigation comes in many forms and dimensions. Small claims cases involves small amounts of money and take a few weeks to complete, while complex class action toxic tort cases involve many millions of dollars, potentially hundreds of parties and can take years, even decades, to complete. It is crucial for judges and clients to employ litigation facilitation methods to manage an attorney or attorneys handling the case to unburden court time and client resources.

Litigation management can be a complex undertaking. Legal arguments must be formulated, deadlines must be met, clients must be kept informed and all the while the attorney must adhere to a plethora of rules regulating attorney procedures and conduct in the course of a litigation matter. A common set of rules in many jurisdictions are geared towards reducing the amount of subject matter in contention by, for example, requiring attorneys to confer in good faith with each other before filing a hearing or noticing a hearing for oral argument, or requiring attorneys to come to an agreement with regards to issues not in dispute, narrowing issues, agreed orders, scheduling depositions, etc. An example of such a rule is Rule 7.1-A-3 of the Local Rules of the United States District Court for the Southern District of Florida, reproduced in relevant part below:

“Prior to filing any motion in a civil case, except a motion for injunctive relief, . . . , counsel for the movant shall confer (orally or in writing), or make reasonable effort to confer (orally or in writing), with all parties or non-parties who may be affected by the relief sought in the motion in a good faith effort to resolve by agreement the issues to be raised in the motion. Counsel conferring with movant's counsel shall cooperate and act in good faith in attempting to resolve the dispute.”

Because rules such as the rule excerpted above require good faith efforts and are left to the (biased and partial) attorneys in a case to handle, it can be difficult for judges and clients to monitor attorney compliance with these rules. Since opposing attorneys on a case are adverse to each other and the adversity sometimes leads to negative feelings, personal vendettas or generally unprofessional behavior, the good faith rules as described above are often manipulated or simply defied by the attorneys. For example, an attorney may call the opposing attorney late at night in order to technically comply with the rule, but because of the time of the telephone call, no conference will take place. In another example, attorneys may sometimes lie and simply state that they called, emailed or faxed the opposing side, when in fact they did not. Likewise, some attorneys may lie and state that they did not receive a call, email or fax, when in fact they did. When negative events such as these occur, a judge or magistrate must often get involved and initiate either a hearing or another set of motions and responses, or both, in order to determine who did or did not comply with the rules. This can be time-consuming and wasteful. Lack of good faith attorney communication regarding the subject matter of motions, scheduling depositions and even formulating agreed orders burdens the courts' calendars and clients' interests. Further, this situation prolongs the litigation, which results in increased legal costs for the clients paying the attorneys as well as lessening chances of amicable resolution due to unrecoverable legal expenditures. Additionally, this situation further burdens an already overworked legal system, requiring the courts and their clerks to add more personnel.

Therefore a need exists to overcome the problems discussed above, and particularly for a way to facilitate litigation management and monitoring to more efficiently deal with attorney adherence to good faith rule compliance.

### SUMMARY OF THE INVENTION

The present invention, according to a preferred embodiment, overcomes problems with the prior art by providing an efficient and easy-to-implement litigation management system utilizing automatic rule compliance.

In an embodiment of the present invention, a method on a computer for providing litigation management is disclosed. The method includes receiving from a first party to a lawsuit at least one proposed action and logging a time and date of the proposed action. The method further includes sending a message to at least one opposing party in the law suit, wherein the message invites feedback from the at least one opposing party in accordance with a court rule. In one alternative, the method further includes receiving feedback from the at least one opposing party in the law suit, logging a time, a date and content of the feedback, determining whether the feedback complies with the court rule based on the time, date and content of the feedback, and recommending sanctions of the at least one opposing party if the feedback does not comply with the court rule. In another alternative, the method further includes allowing a time period for compliance with the court rule to pass without receiving feedback from the at least one opposing party, determining that the at least one opposing party has not complied with the court rule, and recommending sanctions of the at least one opposing party.

In yet another embodiment of the present invention, a computer system for providing litigation management is disclosed. The computer system includes an interface for receiving from a first party to a lawsuit at least one proposed action. The computer system further includes a processor configured for logging a time and date of the proposed action and generating a message inviting feedback from at least one opposing party in accordance with a court rule. The computer system further includes a transmitter for sending the message to the at least one opposing party in the law suit

In yet another embodiment of the present invention, a computer readable medium for providing online litigation management is disclosed. The computer readable medium includes instructions for receiving from a first party to a lawsuit at least one proposed action and logging a time and date of the proposed action. The computer readable medium further includes instructions for sending a message to at least one opposing party in the law suit, wherein the message invites feedback from the at least one opposing party in accordance with a court rule. In one alternative, the computer readable medium further includes instructions for receiving feedback from the at least one opposing party in the law suit, logging a time, a date and content of the feedback, determining whether the feedback complies with the court rule based on the time, date and content of the feedback, and recommending sanctions of the at least one opposing party if the feedback does not comply with the court rule.

The foregoing and other features and advantages of the present invention will be apparent from the following more particular description of the preferred embodiments of the invention, as illustrated in the accompanying drawings.

### BRIEF DESCRIPTION OF THE DRAWINGS

The subject matter, which is regarded as the invention, is particularly pointed out and distinctly claimed in the claims at the conclusion of the specification. The foregoing and other features and also the advantages of the invention will be apparent from the following detailed description taken in conjunction with the accompanying drawings.

FIG. 1 is a block diagram illustrating the overall architecture of one embodiment of the present invention.

FIG. 2 is an operational flow diagram showing the setup process according to one embodiment of the present invention.

FIG. 3 is an operational flow diagram showing a proposed action handling process according to one embodiment of the present invention.

FIG. 4 is an operational flow diagram showing a proposed scheduling process according to one embodiment of the present invention.

FIG. 5 is a block diagram of an information processing system useful for implementing the present invention.

FIG. 6 is a block diagram illustrating the monitoring feature of one embodiment of the present invention.

### DETAILED DESCRIPTION OF THE PREFERRED EMBODIMENTS

It should be understood that these embodiments are only examples of the many advantageous uses of the innovative teachings herein. In general, statements made in the specification of the present application do not necessarily limit any of the various claimed inventions. Moreover, some statements may apply to some inventive features but not to others. In general, unless otherwise indicated, singular elements may be in the plural and vice versa with no loss of generality. In the drawing like numerals refer to like parts through several views.

The present invention, according to a preferred embodiment, overcomes problems with the prior art by providing on-line litigation management in an efficient, inexpensive and easy-to-implement computer system through the Internet utilizing a secure, verifiable on-line facilitation and monitoring system to ensure attorney good faith compliance with court requirements and procedures. The present invention provides users with the ability to monitor attorneys' good faith attempts to amicably resolve issues which arise during litigation without burdening the court's time or the client's resources.

One advantage of the present invention is verifiable good faith compliance with common court rules aimed towards reducing the amount of subject matter in contention by, for example, requiring attorneys to negotiate in good faith with each other before filing a motion, noticing a hearing or requiring attorneys to come to an agreement with regards to dates for depositions, etc. An example of such a rule is Rule 7.1-A-3 of the Local Rules of the United States District Court for the Southern District of Florida, reproduced in relevant part above. Because the present invention automates the process of compliance with these rules, manipulation or non-compliance with the rules by the attorneys is reduced or eliminated.

For example, the time and date that a moving party attempted to confer with opposing counsel regarding a proposed action or motion, a proposed schedule or a proposed hearing is logged and stored for viewing by any party involved, including judges, magistrates, attorneys, administrators, clients or paralegals. Likewise, any calls, emails or faxes made in an attempt to comply with the rules are logged and stored for viewing by any party involved, thereby reducing or eliminating the possibility of misrepresentation or misunderstandings. Thus, the present invention reduces or eliminates the probability of discovery disputes and the initiation of either a hearing or an additional set of motions, or both, in order to determine who did or did not comply with the rules. Therefore, the present invention saves all parties and the courts time and effort by simplifying and streamlining the litigation, resulting in reduced legal costs for the clients paying the attorneys and a savings of resources for the legal system.

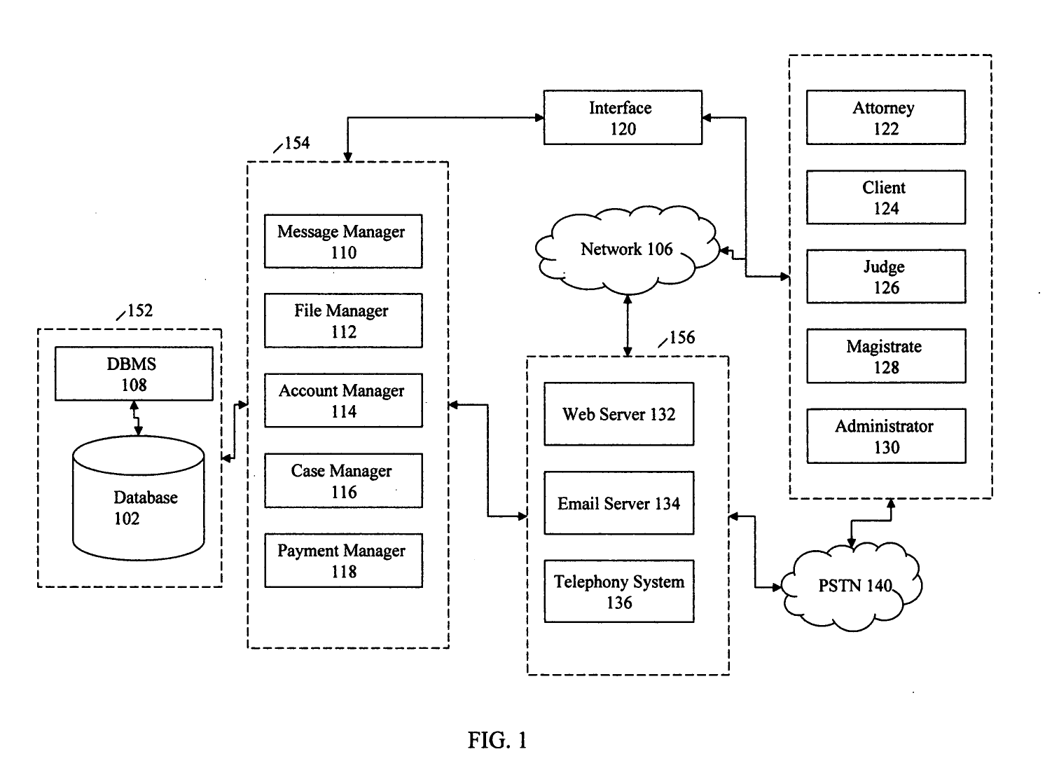

FIG. 1 is a block diagram illustrating the overall architecture of one embodiment of the present invention. The exemplary embodiments of the present invention adhere to the system architecture of FIG. 1. FIG. 1 shows an embodiment of the present invention wherein users, such as attorneys 122, clients 124, judges 126, magistrates 128 or administrators 130 can interact with a litigation management system over a network 106, the telephone system 140 or an interface 120, such as in an enterprise or client-server implementation of a litigation management system that services multiple users in more than one location and for multiple cases or projects. FIG. 1 shows user computers 122 through 130 connected to a network 106, the Public Service Telephone System (PSTN) 140 or an interface 120. It should be noted that although FIG. 1 shows only five user computers 122 through 130, the system of the present invention supports any number of user computers.

FIG. 1 also shows a litigation management system consisting of a database group 152, a manager group 154 and a communication group 156. The manager group 154 and the communication group 156 are connected to the network 106, the PSTN 140 and an interface 120. The database group 152, manager group 154 and communication group 156 are described in more detail with reference to the figures below.

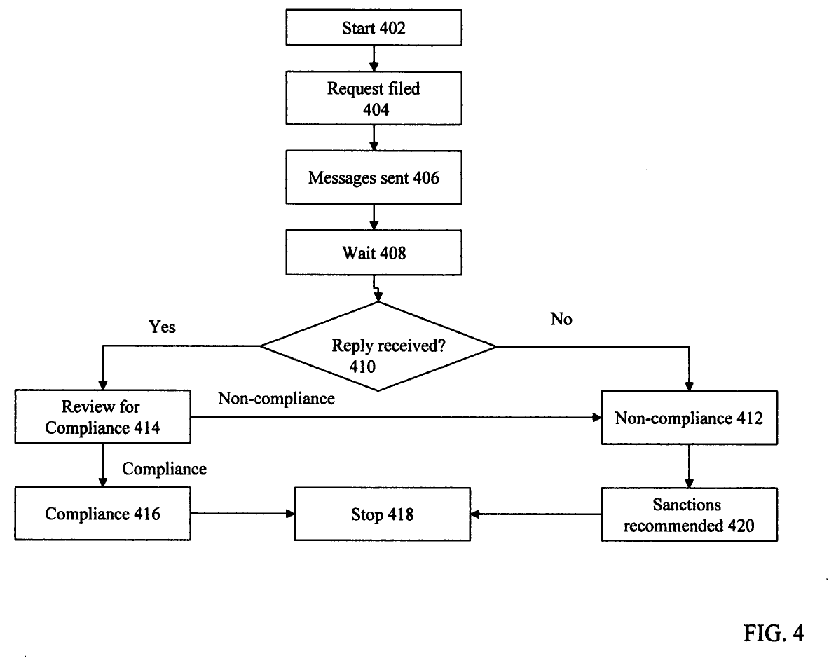

In an embodiment of the present invention, the computer systems of user computers 122 through 130 and groups 152 through 156 are one or more Personal Computers (PCs), Personal Digital Assistants (PDAs), hand held computers, palm top computers, lap top computers, smart phones, game consoles or any other information processing devices. A PC can be one or more IBM or compatible PC workstations running a Microsoft Windows or LINUX operating system, one or more Macintosh computers running a Mac OS operating system, or an equivalent. In another embodiment, the user computers 122 through 130 and groups 152 through 156 are a server system, such as SUN Ultra workstations running a SunOS operating system or IBM RS/6000 workstations and servers running the AIX operating system. The computer systems of user computers 122 through 130 and groups 152 through 156 are described in greater detail below with reference to FIG. 4.

In an embodiment of the present invention, the network 106 is a circuit switched network. In another embodiment, the network 106 is a packet switched network. The packet switched network is a wide area network (WAN), such as the global Internet (or the World Wide Web), a private WAN, a local area network (LAN), a telecommunications network or any combination of the above-mentioned networks. In yet another embodiment, the structure of the network 106 is a wired network, a wireless network, a broadcast network or a point-to-point network. The PSTN 140 can be the public switched telephone system or a private telephone system.

With regards to the client-server nature of the present invention, FIG. 1 shows the components of the litigation management system, including a database group 152, a manager group 154 and a communication group 156. The database group 152 includes a database 102 and a database management system 108. The database 102 is a repository for data used by the litigation management system during the course of litigation or other projects. The database 102 includes all information necessary for performing the functions of the litigation management system, including creating cases, updating cases, processing cases, enforcing compliance with rules, etc. These functions are described in greater detail below. The database 102 also includes information that is modified or accessed by the litigation management system during the course of litigation or other projects. Database 102 can be any commercially database, such as an Oracle Database, Enterprise or Personal Edition, available from Oracle Corporation, or a Microsoft SQL Server or Access 2000 database available from Microsoft Corporation.

Database management system 108 is an application that controls the organization, storage and retrieval of data (fields, records and files) in database 102. The database management system 108 accepts requests for data from the litigation management system and instructs the operating system to transfer the appropriate data. Database management system 108 may also control the security and integrity of the database 102. Data security prevents unauthorized users from viewing or updating certain portions of the database 102. Database management system 108 can be any commercially database management system, such as the Oracle E-Business Suite available from Oracle Corporation.

FIG. 1 also shows the communication group 156 of the litigation management system, which performs substantially the communication functions of the present invention, as described in greater detail below. Communication group 156 connects directly to the network 106 via a network interface, such as a network interface card. Optionally, the litigation management system includes a Web server 132 that connects to the network 106 via a network interface. The project litigation management system is logically connected to the Web server 132, which provides a Web interface available to users (such as users 122-130) of the litigation management system. This option is advantageous as a Web interface allows any users having a Web browser to connect to the litigation management system. A Web interface provides a simple, efficient, highly compatible, economical and highly available connection to the litigation management system to a wide range of users.

In another alternative, the litigation management system includes an email server 134, such as a Simple Mail Transfer Protocol (SMTP) server, that connects to the network 106 via a network interface. The project litigation management system is logically connected to the email server 134, which provides an email interface available to users of the litigation management system. This option is advantageous as an email interface allows any users having an email client and a Web connection to communicate with the litigation management system via email. An email interface provides a simple, easy-to-use and highly available connection to the litigation management system to a wide range of users.

In yet another alternative, the litigation management system includes a telephony system 136 that connects to the network 106 via a network interface or to the PSTN 140 via a telephony interface. The project litigation management system is logically connected to the telephony system 136, which provides a telephony interface available to users of the litigation management system. The telephony system 136 provides users with telephone access to the litigation management system. The telephony system 136 allows users to call in via a telephone connection to submit, modify or receive data via a voice option or modem access. The telephony system 136 further allows users receive telephone calls to submit, modify or receive data via a voice option or modem access. This option is advantageous as a telephony interface allows any users having a telephone connection to communicate with the litigation management system via telephone. A telephony interface provides a simple and widely available connection to the litigation management system to a wide range of users.

FIG. 1 also shows the manager group 154 of the litigation management system, which performs substantially the functions of the present invention, as described in greater detail below. The manager group 154 of the litigation management system includes a message manager 110, a file manager 112, an account manager 114, a case manager 116 and a payment manager 118. The message manager 110 manages any messages that are generated, sent or received by the litigation management system. Messages are generated by the litigation management system during the rule compliance determination process, as described in greater detail below. Messages are further sent and received to and from the litigating parties by the litigation management system during the rule compliance determination process, as described in greater detail below. The message manager 110 logs the time and date of all messages on an unalterable database 102 which verifies the date, time and nature of the communication.

Messages that are managed by the message manager 110 can comprises any one of email messages, a hyper text transfer protocol (HTTP) request, a transmission control protocol/internet protocol (TCP/IP) request, a file transfer protocol (FTP) request and an electronic data interchange (EDI) request.

The file manager 112 manages any files or documents that are generated, stored, sent or received by the litigation management system. Files and documents, such as motions, requests and petitions, are generated, stored, sent or received by the litigation management system during the course of litigation and during the rule compliance determination process, as described in greater detail below. Files that are managed by the file manager 112 comprises any one of email messages, word processing documents, text files, data files, spreadsheet program files, etc. The file manager 112 can interface with the message manager 110 such that messages can be generated and sent when files are generated, stored, sent or received by the litigation management system.

The account manager 114 manages the creation, modification and processing of user accounts. Accounts are created for various users such as attorneys 122, clients 124, judges 126, magistrates 128 or administrators 130 that interact with the litigation management system at various times. User accounts include user data, permissions, related files, related messages, payment information and case information. Users may log onto the litigation management system via any one of the connections in the communication group 156 to perform a variety of actions, such as making payments or requesting permissions. The account manager 114 can interface with the message manager 110 such that messages can be generated and sent when accounts are created, modified or processes by the litigation management system.

The case manager 116 manages lawsuits by organizing those actions or motions that have been filed, those actions or motions that remain to be filed, related deadlines and the corresponding decisions that have been, or remain to be, generated by the judge or magistrate. The case manager 116 keeps a list of all actions or motions that have been filed, including the time and date they were filed and the individual who filed them. The case manager 116 further keeps a list of all actions or motions that remain to be filed, including the time and date of the deadlines and the individual who must file them. The case manager 116 keeps a list of all decisions that have been, or remain to be, generated by the judge or magistrate, including the time and date they were generated and the individual who generated them, or the time and date of the deadline (if any) and the individual who must generate them. The case manager 116 can interface with the message manager 110 such that messages can be generated and sent by the litigation management system when actions or motions are filed, when the deadlines for filing actions or motions are near or when the deadlines for filing actions or motions are reached or passed.

The payment manager 118 manages the payment of court fees, court costs, awarded fees or other monies. The payment manager 118 these payments by keeping a list of those court fees, court costs, awarded fees or other monies that have been paid, those that remain to be paid, related deadlines and the corresponding sanctions or penalties that must be paid if payments are not received by a certain date. The payment manager 118 can interface with the message manager 110 such that messages can be generated and sent by the litigation management system when payment of court fees, court costs, awarded fees or other monies is made, when the deadlines for paying are near or when the deadlines for paying are reached or passed.

In one embodiment of the present invention, the mechanism by which the users 122-130 interact with the litigation management system is a client application residing on the computer of the user. These client applications can comprise any one of a C++ program, a Visual Basic program, a Java applet, a Java scriptlet, a Java script, a Perl script, an Active X control or any self-sufficient application executing on a user computer. The users 122-130 can communicate with the litigation management system via a Web interface such as a commercially available Web browser, e.g., Netscape Navigator and Microsoft Internet Explorer.

In another embodiment of the present invention, the mechanism by which the users 122-130 interact with the litigation management system is an interface 120 that connects directly to the manager group 154. The interface 120 can be a client application, such as an application programmed in C++, Visual Basic, a Java applet, a Java scriptlet, Java script, Perl script, an Active X control or any self-sufficient application executing on a user computer. The interface 120 can communicate with the litigation management system via a Web interface such as a commercially available Web browser wherein the user enters and/or modifies via a Web page.

It should be noted that in the embodiment of the present invention described above, the computers of users 122-130 are depicted as separate from the litigation management system. In this embodiment, the computers of users 122-130 communicate with the computer system of the litigation management system over a network 106, PSTN 140 or other communication medium. In an alternative embodiment of the present invention, any one or all of the computers of users 122-130 can be integrated with the computer system of the litigation management system. In this alternative embodiment, those modules or clients that are integrated with the litigation management system share the same resources as the litigation management system.

As explained above, the present invention overcomes problems with the prior art by providing online litigation management through the implementation of verifiable good faith compliance with common court rules aimed towards reducing the amount of subject matter in contention by, for example, requiring attorneys to negotiate in good faith with each other before filing a motion or noticing a hearing, or requiring attorneys to come to an agreement with regards to dates for depositions, etc. As such a brief synopsis of the overall process of litigation, with a brief description of the motions and requests that are asserted, is described below.

In this first stage of the lawsuit (known as the pleadings), a complaint is filed describing the basic facts of the case, the names of the parties involved, references to the legal theory to back up the claim and a statement of the requested relief. There can be more than one person or party on either side of the lawsuit. In fact, there can be many defendants and many plaintiffs. Once the complaint is completed, it is filed in the selected court The filed complaint is delivered to the defendant in a process called service of process. In addition to the complaint, the defendant is also served a summons. The summons explains what the defendant needs to do as a result of the complaint. When it is difficult to track down the defendant, constructive service is necessary. This means the documents can be mailed to the defendant's workplace, last known home address, and/or posted in the newspaper under the “Legal Notices” section.

Once the defendant has been served, he must respond to your complaint within 20 to 30 days (depending on the jurisdiction) by filing responsive pleadings. One type of responsive pleading is called an answer. In that document, the defendant might totally deny the complaint, deny certain parts of it, point a finger at someone else not named in the complaint, point out technical problems in the complaint itself, etc. In other words, an answer's purpose is to somehow modify the complaint.

If the defendant's responsive pleading isn't an answer, then it must be in the form of a motion. A motion introduces some other question to the court that the judge must rule on. Motions can be filed at any time during the trial up until the final judgment is made. The party who initiates the motion is called the mover, or movant, and the other party is called the opposing party. When one party files a motion, the opposing party can file a request for the judge to deny the motion. For example, the defendant may file a motion to dismiss. The defendant may also file a countersuit against the plaintiff, which makes the plaintiff the counter-defendant. This begins a new complaint process; however, the two cases will be heard as one lawsuit. If the defendant's response isn't filed within the allowed time (usually 20 to 30 days, but can be less in some courts), a default judgment may be entered, meaning the plaintiff is victorious. However, judges often allow the defendant additional time to file responsive pleadings if there is a good reason for not getting it done on time. Once the pleadings are filed, discovery begins.

All of the legwork in gathering facts and evidence for a case is known as “discovery.” While each court may have different discovery rules, the basics are the same. Discovery is the act and procedure of gathering every bit of evidence and information, no matter how trivial it may appear, from both parties involved as well as others outside of the suit It can be information about the facts of the case, documents that may be important to the case, background information on the parties involved, names of others who might know more. Information from a conversation that would never be admitted in court can be part of the discovery process. The justification for this is that it might be possible to gain true evidence as a result of the knowledge gained from a discussion among the defendant, witnesses, or others related to the case.

To save time and money, some judges may require that each side of the lawsuit turn over all basic information it has regarding the case. In addition to this, attorneys gather information through requests for production of documents, requests for admissions, depositions, interrogatories, and requests for independent medical examination (IME). The judge will often schedule conferences during the discovery stage. These can cover things like the status of discovery (i.e., whether it is moving along as it should be), settlement potential (i.e., whether there is a chance for settlement at this stage), or resolving any discovery disputes that may be arising. Motions also can be filed if any of the discovery requests are not being met. For example, a motion for more responsive answers can be filed. This type of motion requires documentation of each discovery request, the response, and the reason the response is inadequate.

In the request for production of documents, each attorney requests documents that will help him prove his case. These documents can include business records, traffic or police reports, or anything else that might apply. Requests for admissions are requests made of those involved on the other side of the suit to state under oath that certain facts are true or untrue. This is to save time and money gathering evidence to back up facts that are either obvious or prove that documents are authentic. Interrogatories are questions the attorneys prepare to send to the other party to answer. The answers to these questions can become part of the sworn testimony used in the case.

Depositions are interviews the attorneys have with witnesses or anyone else who may be able to provide information for the case. Here the attorneys find out what the opposition is going to say in his testimony, as well as assess his ability as a witness. When someone is questioned (known as being deposed), attorneys from both sides can attend and ask questions. Independent medical examinations (IMEs) are medical examinations by a physician who is not involved with anyone in the case, and has not treated the person having the IME. While fairly rare, IMEs are sometimes performed for cases involving some aspect of the physical condition of the plaintiff or the defendant.

Motions to quash may be filed if one party is trying to get protected information from the other party during discovery. If the judge allows the information to be admitted, then another motion (motion to seal matters produced upon discovery) can be filed. If either party of the lawsuit doesn't provide information he is supposed to provide, then the judge can also impose a sanction against him. This means he will fined for not providing the information. The sanction can be against either the attorney or the client. It depends on which person is refusing to provide the information.

The whole purpose of a trial is to resolve disputes about the facts of the case. If neither party can dispute the facts, then a motion for summary judgment can be filed. A summary judgment means the judge looks at the facts, applies the law, and makes a ruling. If there is any dispute about the facts, then the judge will deny the motion. In other words, there is no reason to bring a case to trial unless there is evidence that should be heard by a jury. Other motions include: a motion to dismiss, a motion for judgment, a motion for judgment notwithstanding verdict. If the parties decide to settle, then a formal offer of settlement is generated.

If all of the pre-trial requirements (discovery, motions, negotiations, etc.) are completed the parties still haven't settled the case, then a memorandum to set trial date (this is also sometimes called a motion to set trial date or an at-issue memorandum) is filed. This document can include information like the details of the case, the demands, whether a party requests a jury trial or bench trial, any recent settlement -offers and an estimate of-how long the trial will last. Note that these types of procedures vary a lot from state to state. In some states there is simply a mandatory status conference at a specified time after the suit is filed in order to set the date for trial.

Before the trial begins, pre-trial conferences are sometimes called to essentially lay out the game plan for the entire trial. (These conferences may not be necessary for all trials.) At these conferences, both attorneys go over what they will present, in what order they will present it, and any issues that will need to be presented separately in order to prevent predisposing the jury about any of the facts. In addition to the meetings, the attorneys sometimes have to submit a pretrial brief that outlines all of the facts of the case with indications of whether the facts are disputed or undisputed. The brief also has to detail their exhibits and evidence and provide a list of witnesses The judge will also request one of the attorneys to submit a “pretrial order,” which is a document that describes what will happen in the trial. Just as with the other procedures; these vary from state to state. In some areas, a witness list is all that is necessary.

If the trial will be heard by a jury, then the selection of the jury begins. Jury pools are pulled from a list of registered voters in the area In some courts, the judge asks the potential jurors all of the questions, but in others the attorneys are also be allowed to ask questions. The jurors are questioned in order to screen out anyone who has personal knowledge of the case, knows someone on either side of the case, or has had a similar experience to the one presented in the case. If allowed, the attorneys may ask additional questions in order to screen out potential jurors who may not support their side of the case. The attorneys may then file motions to exclude certain jurors from the case.

Since evidence is usually introduced through the witnesses' testimony, the order in which the witnesses take the stand and the questions they are asked are set up with precision. In civil cases, the plaintiffs attorney is allowed to call the defendant to the stand, as well. Attorneys can also introduce evidence (if both sides have agreed that it can be introduced) by stipulation.

After the trial, the plaintiffs attorney (if victorious) must evaluate the costs and come up with the totals in order to formalize the judgment. The clerk of court then files a notice of entry of judgment.” The plaintiff also must determine how he's going to enforce the judgment. If the defendant must pay the plaintiff money, then (depending on the state) the plaintiff may have options on how to collect—this may include garnishing wages, taking assets to cover the dollar amount, or putting a lien on property. While these decisions are being made, there is always the possibility that the defendant is still trying to win the case. The defendant may try to get the judge to overturn the ruling, or request a new trial based on some problem that occurred during the trial, or appeal the case to a higher court. If the jury's verdict was off-base to most reasonable people, then the judge might agree to the motion for judgment notwithstanding verdict and change the verdict.

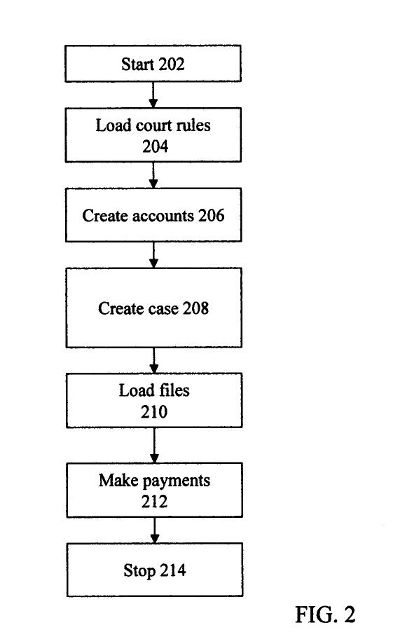

FIG. 2 is an operational flow diagram showing the setup process according to one embodiment of the present invention. The operation and control flow of FIG. 2 begins with step 202 and proceeds directly to step 204.

In step 204, the common court rules aimed towards reducing the amount of subject matter in contention are loaded into the database 102 by a user such as the administrator 130. An example of such a rule is Rule 7.1-A-3 of the Local Rules of the United States District Court for the Southern District of Florida. In step 206, all accounts for the pertinent users, such as attorneys 122, clients 124, judges -126, magistrates 128 or administrators 130 are created by the account manager 114 of the litigation management system. The users themselves may create the accounts via a communication medium such as network 106 or the accounts may be created by a user such as the administrator 130.

In step 208, a case is created by case manager 116 for the lawsuit at issue. The users themselves may create the case via a communication medium such as network 106 or the case may be created by a user such as the administrator 130. In step 210, all relevant files, such as the complaint or other pleadings that commence the case are loaded into the database 102 by a user such as the administrator 130. The users themselves may also load the files via a communication medium such as network 106. In step 212, all relevant court fees, court costs or other monies are requested and optionally paid via the payment manager 118. The users themselves may make payments via a communication medium such as network 106. In step 214, the control flow of FIG. 2 stops.

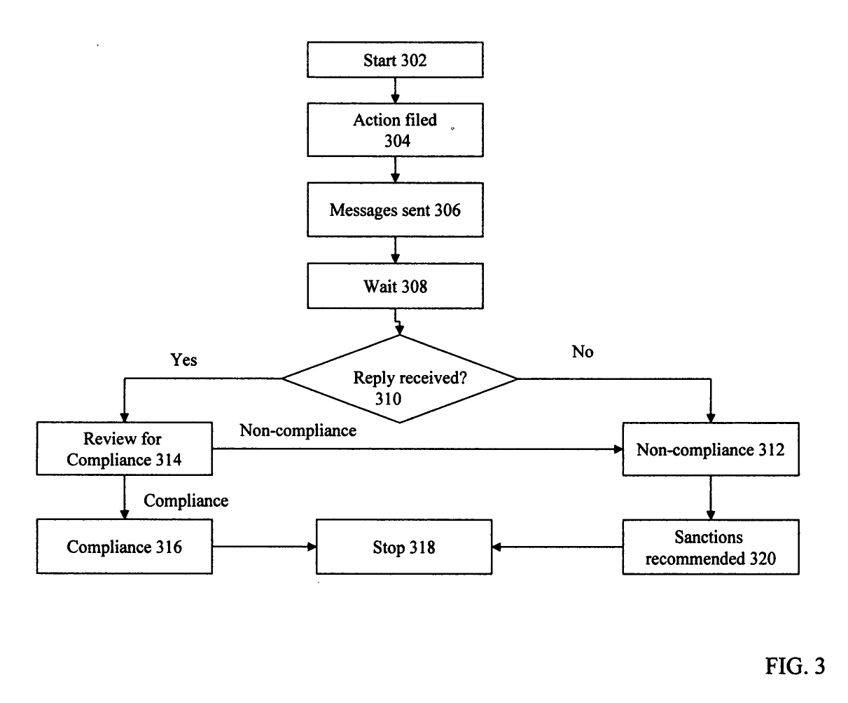

FIG. 3 is an operational flow diagram showing a proposed action handling process according to one embodiment of the present invention. The operation and control flow of FIG. 3 begins with step 302 and proceeds directly to step 304.

In step 304, a proposed action, such as a motion, a discovery request, an offer, a stipulation, a notice or a request is filed by a moving party, i.e., a movant, such as an attorney 122. The message manager 110 logs the time and date of the proposed action on an unalterable database 102 which verifies the date, time and nature of the communication. The proposed action is filed via the case manager -1-16. In step 306, the message manager 110 of the litigation management system sends a message to the opposing party, such as another attorney, requesting feedback on the submitted proposed action. The message manager I 1O logs the time and date of the message sent on an unalterable database 102 which verifies the date, time and nature of the communication.

In step 308, the litigation management system waits a specified period of time for a response. If no response is received by the opposing party in step 310, then in step 312, the opposing party is deemed to be in non-compliance with the rule loaded in step 204 of FIG. 2 above. In optional step 320, sanctions are recommended for the party in non-compliance.

If a response is received by the opposing party in step 310, then in step 314, the feedback is reviewed for compliance with the rule loaded in step 204 of FIG. 2 above. The message manager 110 logs the time and date of the response on an unalterable database 102 which verifies the date, time and nature of the communication. If, among other criteria, the feedback does not show an attitude of good faith or the feedback indicates an unwillingness to negotiate or confer for no good reason, then in step 312 the opposing party is deemed to be in non-compliance with the rule loaded in step 204 of FIG. 2 above. If, among other criteria, the feedback shows an attitude of good faith and the feedback indicates a willingness to negotiate or confer, then in step 316 the opposing party is deemed to be in compliance with the rule. In step 318, the control flow of FIG. 3 stops.

In one embodiment of the present invention, any of the users 122-130 having an account with the litigation management system may have access to at least view (optionally, to edit or delete) any proposed actions, files or messages that are generated during the process of the control flow of FIG. 3.

FIG. 4 is an operational flow diagram showing a proposed scheduling process according to one embodiment of the present invention. The operation and control flow of FIG. 4 begins with step 402 and proceeds directly to step 404.

In step 404, a request to set a meeting, hearing or deposition date, is filed by a movant, such as an attorney 122. The request is filed via the case manager 116. The case manager I 16 or the message manager 110, or both, logs the time and date of the request on an unalterable database 102 which verifies the date, time and nature of the communication. In step 406, the message manager 110 of the litigation management system sends a message to the opposing party, such as another attorney, requesting feedback on the submitted request.

In step 408, the litigation management system waits a specified period of time for a response. If no response is received by the opposing party in step 410, then in step 412, the opposing party is deemed to be in non-compliance with the rule loaded in step 204 of FIG. 2 above. In optional step 420, sanctions are recommended for the party in non-compliance.

If a response is received by the opposing party in step 410, then in step 414, the feedback is reviewed for compliance with the rule loaded in step 204 of FIG. 2 above. The message manager 110 logs the time and date of the response on an unalterable database 102 which verifies the date, time and nature of the communication. If, among other criteria, the feedback does not show an attitude of good faith or the feedback indicates an unwillingness to negotiate or confer for no good reason, then in step 412 the opposing party is deemed to be in non-compliance with the rule loaded in step 204 of FIG. 2 above. If, among other criteria, the feedback shows an attitude of good faith and the feedback indicates a willingness to negotiate or confer, then in step 416 the opposing party is deemed to be in compliance with the rule. In step 418, the control flow of FIG. 4 stops.

Thus, the control flow of FIG. 4 allows attorneys to exchange dates and schedules via a network, such as the Internet, to schedule depositions, hearings, etc. and minimize scheduling conflicts. In one embodiment of the present invention, any of the users 122-130 having an account with the litigation management system may have access to at least view (optionally, to edit or delete) any requests, files or messages that are generated during the process of the control flow of FIG. 4.

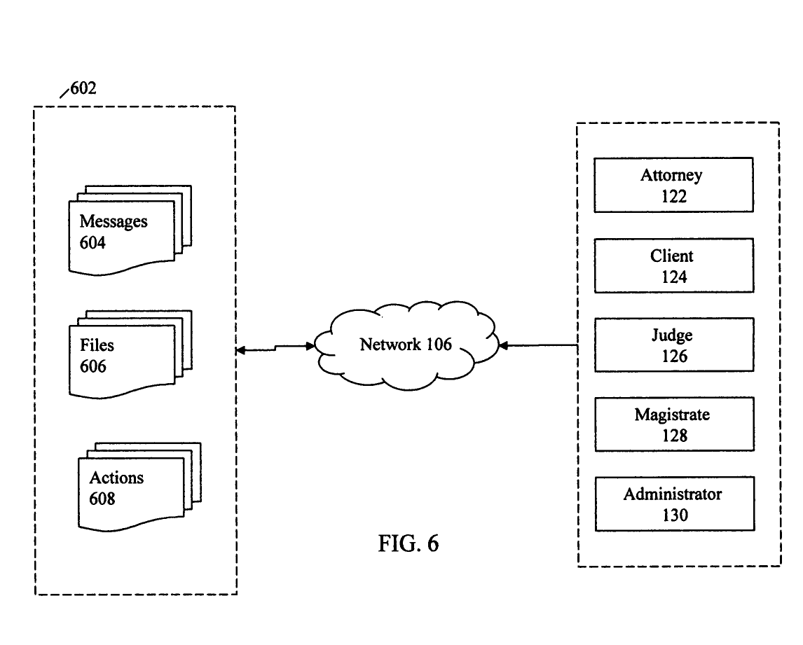

FIG. 6 is a block diagram illustrating the monitoring feature of one embodiment of the present invention. FIG. 6 shows an embodiment of the present invention wherein users, such as attorneys 122, clients 124, judges 126, magistrates 128 or administrators 130 can interact with the litigation management system over a network 106 (or other interfaces such as the telephone system 140 or an interface 120, as described above) to monitor good faith compliance with court rules.

FIG. 6 shows that a data group 602 composed of elements of data that are typically stored in database 102. Messages 604, which are managed by message manager 110 comprise all or some of the messages pertinent to a particular issue, such as a proposed action or a hearing date, that is presented for conference between the attorneys, in accordance with a court rule. Likewise, files 606, which are managed by file manager 112, comprise all or some of the files pertinent to the particular issue and actions 608, which are managed by case manager 116, comprise all or some of the court actions or orders pertinent to the particular issue.

Note that all parties, i.e., attorneys 122, clients 124, judges 126, magistrates 128 and administrators 130, can interact with the data group 602 over a network 106. This allows a judge, for example, to access attorney communications via the Internet to assess and monitor good faith compliance with court rules. This further allows a client, for example, to access attorney communications through the Internet to assess and monitor litigation progress, obstacles, attorney performance and reasons for expense.

Thus, the present invention provides an on-line litigation management via the Internet utilizing a monitoring system to ensure attorney good faith compliance with court requirements and procedures. Further, users are provided with the ability to monitor attorneys' good faith attempts to amicably resolve issues which arise during litigation without burdening the court's time or the client's resources.

The present invention can be realized in hardware, software, or a combination of hardware and software in the system described in FIG. 1. A system according to a preferred embodiment of the present invention can be realized in a centralized fashion in one computer system, or in a distributed fashion where different elements are spread across several interconnected computer systems. Any kind of computer system—or other apparatus adapted for carrying out the methods described herein—is suited. A typical combination of hardware and software could be a general-purpose computer system with a computer program that, when being loaded and executed, controls the computer system such that it carries out the methods described herein.

An embodiment of the present invention can also be embedded in a computer program product, which comprises all the features enabling the implementation of the methods described herein, and which—when loaded in a computer system—is able to carry out these methods. Computer program means or computer program as used in the present invention indicates any expression, in any language, code or notation, of a set of instructions intended to cause a system having an information processing capability to perform a particular function either directly or after either or both of the following a) conversion to another language, code or, notation; and b) reproduction in a different material form.

A computer system may include, inter alia, one or more computers and at least a computer readable medium, allowing a computer system, to read data, instructions, messages or message packets, and other computer readable information from the computer readable medium. The computer readable medium may include non-volatile memory, such as ROM, Flash memory, Disk drive memory, CD-ROM, and other permanent storage. Additionally, a computer readable medium may include, for example, volatile storage such as RAM, buffers, cache memory, and network circuits. Furthermore, the computer readable medium may comprise computer readable information in a transitory state medium such as a network link and/or a network interface, including a wired network or a wireless network that allows a computer system to read such computer readable information.

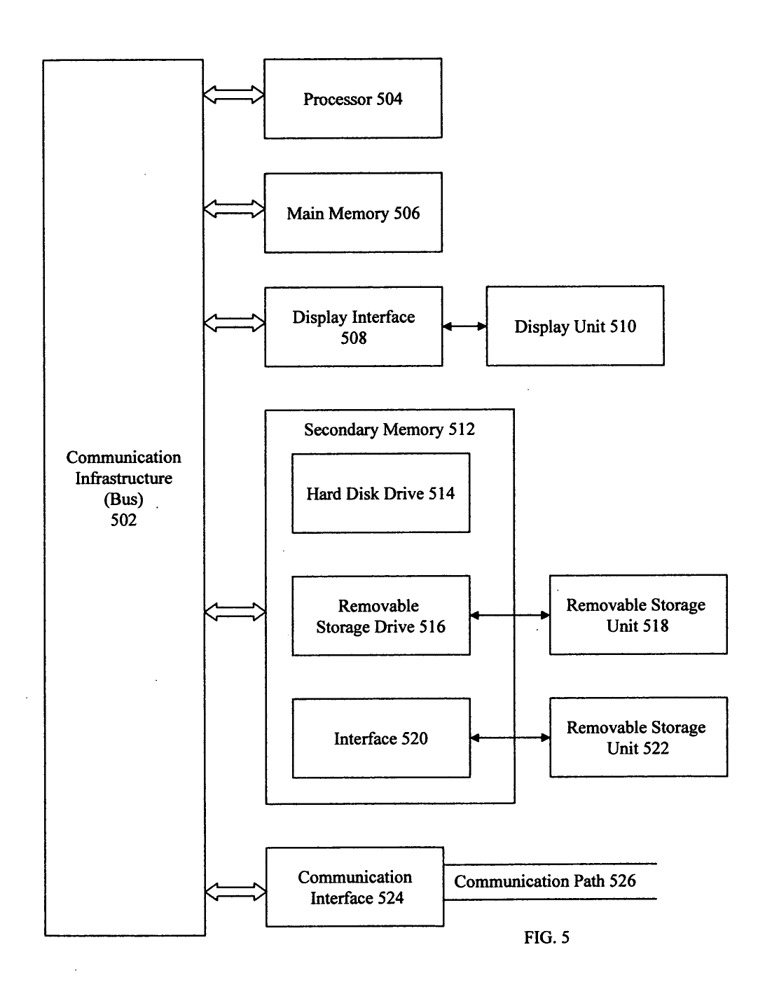

FIG. 5 is a block diagram of a computer system useful for implementing an embodiment of the present invention. The computer system of FIG. 5 is a more detailed representation of computers 122-130 and the computers of the litigation management system of the present invention. The computer system of FIG. 5 includes one or more processors, such as processor 504. The processor 504 is connected to a communication infrastructure 502 (e.g., a communications bus, cross-over bar, or network). Various software embodiments are described in terms of this exemplary computer system. After reading this description, it will become apparent to a person of ordinary skill in the relevant art(s) how to implement the invention using other computer systems and/or computer architectures.

The computer system can include a display interface 508 that forwards graphics, text, and other data from the communication infrastructure 502 (or from a frame buffer not shown) for display on the display unit 510. The computer system also includes a main memory 506, preferably random access memory (RAM), and may also include a secondary memory 512. The secondary memory 512 may include, for example, a hard disk drive 514 and/or a removable storage drive 516, representing a floppy disk drive, a magnetic tape drive, an optical disk drive, etc. The removable storage drive 516 reads from and/or writes to a removable storage unit 518 in a manner well known to those having ordinary skill in the art. Removable storage unit 518, represents, for example, a floppy disk, magnetic tape, optical disk, etc. which is read by and written to by removable storage drive 516. As will be appreciated, the removable storage unit 518 includes a computer usable storage medium having stored therein computer software and/or data.

In alternative embodiments, the secondary memory 512 may include other similar means for allowing computer programs or other instructions to be loaded into the computer system. Such means may include, for example, a removable storage unit 522 and an interface 520. Examples of such may include a program cartridge and cartridge interface (such as that found in video game devices), a removable memory chip (such as an EPROM, or PROM) and associated socket, and other removable storage units 522 and interfaces 520 which allow software and data to be transferred from the removable storage unit 522 to the computer system.

The computer system may also include a communications interface 524. Communications interface 524 allows software and data to be transferred between the computer system and external devices. Examples of communications interface 524 may include a modem, a network interface (such as an Ethernet card), a communications port, a PCMCIA slot and card, etc. Software and data transferred via communications interface 524 are in the form of signals which may be, for example, electronic, electromagnetic, optical, or other signals capable of being received by communications interface 524. These signals are provided to communications interface 524 via a communications path (i.e., channel) 526. This channel 526 carries signals and may be implemented using wire or cable, fiber optics, a phone line, a cellular phone link, an RF link, and/or other communications channels.

In this document, the terms “computer program medium,” “computer usable medium,” and “computer readable medium” are used to generally refer to media such as main memory 506 and secondary memory 512, removable storage drive 516, a hard disk installed in hard disk drive 514, and signals. These computer program products are means for providing software to the computer system. The computer readable medium allows the computer system to read data, instructions, messages or message packets, and other computer readable information from the computer readable medium. The computer readable medium, for example, may include non-volatile memory, such as Floppy, ROM, Flash memory, Disk drive memory, CD-ROM, and other permanent storage. It is useful, for example, for transporting information, such as data and computer instructions, between computer systems. Furthermore, the computer readable medium may comprise computer readable information in a transitory state medium such as a network link and/or a network interface, including a wired network or a wireless network that allows a computer to read such computer readable information.

Computer programs (also called computer control logic) are stored in main memory 506 and/or secondary memory 512. Computer programs may also be received via communications interface 524. Such computer programs, when executed, enable the computer system to perform the features of the present invention as discussed herein. In particular, the computer programs, when executed, enable the processor 504 to perform the features of the computer system. Accordingly, such computer programs represent controllers of the computer system.

Although specific embodiments of the invention have been disclosed, those having ordinary skill in the art will understand that changes can be made to the specific embodiments without departing from the spirit and scope of the invention. The scope of the invention is not to be restricted, therefore, to the specific embodiments. Furthermore, it is intended that the appended claims cover any and all such applications, modifications, and embodiments within the scope of the present invention.

What is claimed is:

1. A method on a computer for providing litigation management, comprising:
receiving from a first party to a lawsuit at least one proposed action;
logging a time and date of the proposed action; and
sending a message to at least one opposing party in the law suit, wherein the message invites feedback from the at least one opposing party in accordance with a court rule.

2. The method of claim 1, further comprising:
receiving feedback from the at least one opposing party in the law suit;
logging a time, a date and content of the feedback;
determining whether the feedback complies with the court rule based on the time, date and content of the feedback; and
recommending sanctions of the at least one opposing party if the feedback does not comply with the court rule.

3. The method of claim 1, further comprising:
allowing a time period for compliance with the court rule to pass without receiving feedback from the at least one opposing party;
determining that the at least one opposing party has not complied with the court rule; and
recommending sanctions of the at least one opposing party.

4. The method of claim 2, further comprising:
if feedback is received from the at least one opposing party in the law suit, then:
logging a time, a date and content of the feedback;
determining whether the feedback complies with the court rule based on the time, date and content of the feedback; and
recommending sanctions of the at least one opposing party if the feedback does not comply with the court rule;
if feedback is not received from the at least one opposing party in the law suit, then:
allowing a time period for compliance with the court rule to pass;
determining that the at least one opposing party has not complied with the court rule; and
recommending sanctions of the at least one opposing party.

5. The method of claim 1, wherein the step of receiving comprises:
receiving from a first party to a lawsuit at least one proposed action in any one of the following forms:
an email;
a hyper text transfer protocol-request;
a transmission control protocol/internet protocol request;
a file transfer protocol request; and
an electronic data interchange request.

6. The method of claim 5, wherein the step of receiving comprises:
receiving from a first party to a lawsuit at least one proposed action comprising any one of:
a motion;
a proposed motion;
a request for a hearing; and
a schedule request.

7. The method of claim 6, wherein the step of sending comprises:
sending a message to at least one opposing party in the law suit, wherein the message invites feedback from the at least one opposing party in accordance with a court rule, and wherein the message comprises any one of:
an email;
a voice mail;
a telephone call;
a fax; and
a postal mail.

8. The method of claim 7, further comprising:
receiving feedback from the at least one opposing party in the law suit;
logging a time, a date and content of the feedback;
determining whether the feedback complies with the court rule based on the time, date and content of the feedback; and
recommending sanctions of the at least one opposing party if the feedback does not comply with the court rule.

9. The method of claim 8, wherein the step of receiving feedback comprises:
receiving feedback from the at least one opposing party in the law suit, wherein the feedback comprises any one of the following:
an email;
a hyper text transfer protocol request;
a transmission control protocol/internet protocol request;
a file transfer protocol request; and
an electronic data interchange request.

10. The method of claim 1, wherein the step of sending comprises:
sending a message to at least one opposing party in the law suit, wherein the message invites feedback from the at least one opposing party in accordance with a court rule requiring each party to confer in good faith with opposing parties within a specified time period before filing a proposed action.

11. A computer readable medium including computer instructions for providing online litigation management, the computer instructions including instructions for:
receiving from a first party to a lawsuit at least one proposed action;
logging a time and date of the proposed action; and
sending a message to at least one opposing party in the law suit, wherein the message invites feedback from the at least one opposing party in accordance with a court rule.

12. The computer readable medium of claim 11, further comprising instructions for:
receiving feedback from the at least one opposing party in the law suit;
logging a time, a date and content of the feedback;
determining whether the feedback complies with the court rule based on the time, date and content of the feedback; and
recommending sanctions of the at least one opposing party if the feedback does not comply with the court rule.

13. The computer readable medium of claim 11, further comprising instructions for:
allowing a time period for compliance with the court rule to pass without receiving feedback from the at least one opposing party;
determining that the at least one opposing party has not complied with the court rule; and
recommending sanctions of the at least one opposing party.

14. The computer readable medium of claim 12, further comprising instructions for:
if feedback is received from the at least one opposing party in the law suit, then:
logging a time, a date and content of the feedback;
determining whether the feedback complies with the court rule based on the time, date and content of the feedback; and
recommending sanctions of the at least one opposing party if the feedback does not comply with the court rule;
if feedback is not received from the at least one opposing party in the law suit, then:
allowing a time period for compliance with the court rule to pass;
determining that the at least one opposing party has not complied with the court rule; and
recommending sanctions of the at least one opposing party.

15. The computer readable medium of claim 11, wherein the instructions for receiving comprise instructions for:
receiving from a first party to a lawsuit at least one proposed action in any one of the following forms:
an email;
a hyper text transfer protocol request;
a transmission control protocol/2internet protocol request;
a file transfer protocol request; and
an electronic data interchange request.

16. The computer readable medium of claim 15, wherein the instructions for sending comprise instructions for:
sending a message to at least one opposing party in the law suit, wherein the message invites feedback from the at least one opposing party in accordance with a court rule, and wherein the message comprises any one of:
an email;
a voice mail;
a telephone call;
a fax; and
a postal mail.

17. A computer system for providing litigation management, comprising:
an interface for receiving from a first party to a lawsuit at least one proposed action;
a processor configured for logging a time and date of the proposed action and generating a message inviting feedback from at least one opposing party in accordance with a court rule; and
a transmitter for sending the message to the at least one opposing party in the law suit.

18. The computer system of claim 17, wherein the processor is further configured for:
reading feedback from the at least one opposing party in the law suit;
logging a time, a date and content of the feedback;
determining whether the feedback complies with the court rule based on the time, date and content of the feedback; and
recommending sanctions of the at least one opposing party if the feedback does not comply with the court rule.

19. The computer system of claim 18, wherein the interface comprises any one of:
a simple mail transfer protocol server;
a web server, and
a graphical user interface provided over a network, such as a WAN.

20. The computer system of claim 18, wherein the transmitter comprises any one of:
a simple mail transfer protocol server;
a web server;
a graphical user interface provided over a network, such as a WAN; and
an automated telephony system.
